(19) United States
(12) Patent Application Publication
(10) Pub. No.: US 2025/0349468 A1
(43) Pub. Date: Nov. 13, 2025

(54) MULTILAYER CERAMIC ELECTRONIC COMPONENT AND METHOD FOR MANUFACTURING MULTILAYER CERAMIC ELECTRONIC COMPONENT

(71) Applicant: KYOCERA Corporation, Kyoto-shi, Kyoto (JP)

(72) Inventors: Hisashi SATO, Kirishima-shi (JP); Hirotoshi ETO, Kirishima-shi (JP); Ryota HASUNUMA, Kirishima-shi (JP)

(73) Assignee: KYOCERA Corporation, Kyoto-shi, Kyoto (JP)

(21) Appl. No.: 18/872,213

(22) PCT Filed: Jun. 2, 2023
(86) PCT No.: PCT/JP2023/020726

§ 371 Date: Dec. 5, 2024

(30) Foreign Application Priority Data
Jun. 7, 2022 (JP) 2022-092384

(51) Int. Cl. H01G 4/224; H01G 4/30; H01G 13/00

(52) U.S. Cl. CPC H01G 4/224; H01G 13/003; H01G 4/30

(57) ABSTRACT

A multilayer ceramic electronic component includes a multilayer portion including multiple internal electrode layers and multiple dielectric layers stacked in a first direction, a pair of main surface protective layers located on opposite main surfaces of the multilayer portion in the first direction, a pair of side protective layers located on opposite side surfaces of the multilayer portion and the main surface protective layers in a second direction, and a plate located adjacent to each of opposite ends of each of the main surface protective layers in a third direction, in which L1≥L2, where L1 is a length of the plate in the third direction, and L2 is a length in the third direction from one end face of the multilayer portion to an end of an internal electrode layer of the internal electrode layers extending from the other end face of the multilayer portion.

### TECHNICAL FIELD

The present disclosure relates to a multilayer ceramic electronic component and a method for manufacturing the multilayer ceramic electronic component.

### BACKGROUND OF INVENTION

A known technique for multilayer ceramic electronic components is described in, for example, Patent Literature 1.

### CITATION LIST

### Patent Literature

Patent Literature 1: Japanese Unexamined Patent Application Publication No. 2012-209539

### SUMMARY

In an aspect of the present disclosure, a multilayer ceramic electronic component includes a multilayer portion including a plurality of internal electrode layers and a plurality of dielectric layers stacked in a first direction, a pair of main surface protective layers located on opposite main surfaces of the multilayer portion in the first direction, a pair of side protective layers located on opposite side surfaces of the multilayer portion and the pair of main surface protective layers in a second direction intersecting with the first direction, and a plate located adjacent to each of opposite ends of each of the pair of main surface protective layers in a third direction intersecting with the second direction. In the multilayer ceramic electronic component, L1≥L2, where L1 is a length of the plate in the third direction, and L2 is a length in the third direction from one end face of the multilayer portion to an end of an internal electrode layer of the plurality of internal electrode layers extending from the other end face of the multilayer portion.

In an aspect of the present disclosure, a method for manufacturing a multilayer ceramic electronic component includes fabricating a multilayer base by placing a pair of main surface protectors on opposite ends of a stack in a first direction, pressing the multilayer base in the first direction, cutting the multilayer base along a plane orthogonal to a third direction intersecting with the first direction to form a pair of cut end faces, cutting the multilayer base along a plane orthogonal to a second direction intersecting with the third direction to form a pair of cut side surfaces, and attaching side protectors to the pair of cut side surfaces. The stack includes a plurality of electrodes and a plurality of dielectric sheets stacked in the first direction. The fabricating the multilayer base includes placing sections of an electrode of the plurality of electrodes on a dielectric sheet in each of the pair of main surface protectors at an interval of a distance P in the third direction, and placing a base plate having a length in the third direction greater than or equal to the distance P at a position overlapping the interval when viewed in the first direction.

### BRIEF DESCRIPTION OF THE DRAWINGS

The objects, features, and advantages of the present disclosure will become more apparent from the following detailed description and the drawings.

FIG. 1 is a schematic diagram of a multilayer ceramic electronic component according to one embodiment of the present disclosure.

FIG. 2A is a schematic diagram of a component body in one embodiment of the present disclosure.

FIG. 2B is a schematic diagram of the component body with its portions separate from one another.

FIG. 3A is a schematic side view of a base component when viewed in a second direction.

FIG. 3B is a schematic side view of a base component in a comparative example when viewed in the second direction.

FIG. 4A is a schematic diagram of an example base component in one embodiment of the present disclosure.

FIG. 4B is a schematic diagram of a base component in a variation.

FIG. 4C is a schematic diagram of a base component in another variation.

FIG. 4D is a schematic diagram of a base component in another variation.

FIG. 5 is a schematic diagram of an end face of a base component in one embodiment of the present disclosure when viewed in a third direction.

FIG. 6 is a schematic diagram of a base component in one embodiment of the present disclosure, with main surface protective layer ends indicated with dashed lines.

FIG. 7A is a schematic diagram of a base component in a variation of one embodiment of the present disclosure.

FIG. 7B is a schematic diagram of a base component in another variation.

FIG. 8A is a schematic diagram of a dielectric sheet on which electrode sheets are formed with a method for manufacturing the multilayer ceramic electronic component according to one embodiment of the present disclosure.

FIG. 8B is a schematic diagram of a dielectric sheet on which electrode sheets are formed in a variation.

FIG. 8C is a schematic diagram of a dielectric sheet on which base plates are formed.

FIG. 9 is a schematic perspective view of a multilayer base with the method for manufacturing the multilayer ceramic electronic component according to one embodiment of the present disclosure.

FIG. 10 is a schematic diagram of cutting lines on the multilayer base with the method for manufacturing the multilayer ceramic electronic component according to one embodiment of the present disclosure.

FIG. 11A is a diagram of base components aligned with their side surfaces being uncovered with the method for manufacturing the multilayer ceramic electronic component according to one embodiment of the present disclosure.

FIG. 11B is a diagram of the base components with side protectors attached to their cut side surfaces on the other side.

FIG. 12 is a schematic diagram of a process of pressing the cut side surfaces being lower surfaces of base precursors against a side protector with the method for manufacturing the multilayer ceramic electronic component according to one embodiment of the present disclosure.

FIG. 13 is a schematic diagram of the component body and underlayers in one embodiment of the present disclosure.

### DESCRIPTION OF EMBODIMENTS

A multilayer ceramic electronic component and a method for manufacturing the multilayer ceramic electronic component according to one or more embodiments of the present disclosure will now be described with reference to the drawings.

Known wiring boards for electronic devices incorporate smaller electronic components with higher functions. Examples of such electronic components include multilayer ceramic capacitors.

Multilayer ceramic capacitors are to increase the volume of the capacitance portion to increase the achievable capacitance. Such multilayer ceramic capacitors are thus to increase the area percentage of internal electrodes by reducing the thickness of dielectrics between internal electrode layers and by reducing a margin portion of an outer shell that protects internal components.

With known means for reducing the margin portion of the outer shell, a base block including the internal electrode layers and ceramic green sheets stacked alternately on one another is cut along two orthogonal cut lines, and thin ceramic protective layers are attached to cut side surfaces on which the internal electrodes are exposed as protective layers.

For example, Patent Literature 1 describes a technique to increase adhesion between ceramic protective layers and green chips or rod-like green blocks. With the technique, ceramic green sheets for side surfaces are attached to the cut side surfaces of the green chips or the rod-like green blocks to form raw ceramic protective layers, and the structure is heated and press-bonded at a temperature less than or equal to 200° C.

However, with the technique described in Patent Literature 1, sufficient moisture resistance is unachievable. Thus, multilayer ceramic electronic components with a higher moisture resistance and a method for manufacturing the multilayer ceramic electronic component are awaited.

A multilayer ceramic electronic component 1 and a method for manufacturing the multilayer ceramic electronic component 1 according to an embodiment of the present disclosure will now be described with reference to the drawings. A multilayer ceramic capacitor will now be described as an example of the multilayer ceramic electronic component 1. However, the multilayer ceramic electronic component to be manufactured in the embodiment of the present disclosure is not limited to the multilayer ceramic capacitor, and may be any of various other multilayer ceramic electronic components such as a multilayer piezoelectric element, a multilayer thermistor, a multilayer chip coil, and a multilayer ceramic substrate.

Note that the drawings used hereafter are schematic and are not necessarily drawn to scale relative to the actual size of each component in the drawings. The embodiments described herein are illustrative, and the components in different embodiments or variations may be partly interchanged or combined.

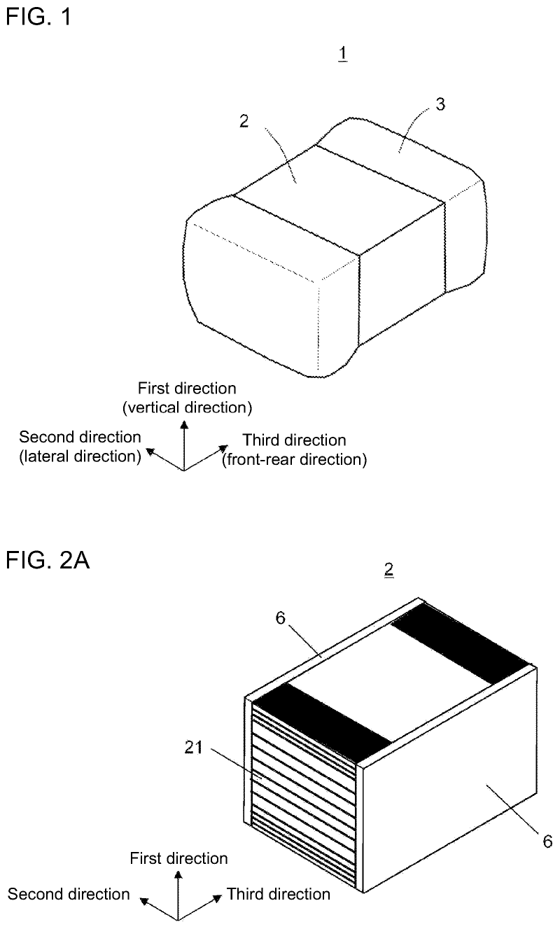

FIG. 1 is a schematic diagram of the multilayer ceramic electronic component 1 according to one embodiment of the present disclosure. The multilayer ceramic electronic component 1 includes a component body 2 and external electrodes 3. The component body 2 is, for example, substantially rectangular, although the component body 2 may have any appropriate shape. The external electrodes 3 are located on, for example, a pair of end faces of the component body 2 and extend to other adjacent faces.

For ease of explanation, some of the drawings include an orthogonal coordinate system defined by a first direction, a second direction, and a third direction. In one or more embodiments of the present disclosure, any direction of the multilayer ceramic electronic component 1 may be the first direction, the second direction, or the third direction. For ease of explanation, the first direction herein is defined as a stacking direction of internal electrode layers 41 and dielectric layers 52 (described later). The second direction is defined as a direction intersecting with the first direction and substantially parallel to short sides of the substantially rectangular component body 2. The third direction is defined as a direction intersecting with the second direction and substantially parallel to long sides of the substantially rectangular component body 2. For ease of explanation, the first direction may be referred to as a vertical direction, the second direction may be referred to as a lateral direction, and the third direction may be referred to as a front-rear direction.

The component body 2 that is substantially rectangular has six surfaces. The component body 2 includes upper and lower surfaces in the first direction defined as main surfaces, right and left surfaces in the second direction defined as side surfaces, and front and rear surfaces in the third direction defined as end faces. Also, a multilayer portion 4 (described later) included in the component body 2 includes main surfaces, side surfaces, and end faces defined in the same or similar manner. Also, main surface protective layers 5 (described later) included in the component body 2 each include main surfaces, side surfaces, and end faces defined in the same or similar manner. Also, a base component 23 (described later) included in the component body 2 includes main surfaces, side surfaces, and end faces defined in the same or similar manner. Also, an unfired base precursor 210 (described later) includes main surfaces, side surfaces, and end faces defined in the same or similar manner. Also, a multilayer base 220 (described later) includes main surfaces, side surfaces, and end faces defined in the same or similar manner.

Each of the external electrodes 3 includes an underlayer connected to the component body 2 and a plated outer layer that facilitates mounting of external wiring to the external electrode 3 by soldering. The underlayer may be applied, by thermal treatment, to the component body 2 after firing, or may be placed on the unfired component body 2 and then fired together with the component body 2. The external electrode 3 may include multiple underlayers and multiple plated outer layers to have an intended function. The external electrode 3 may include the underlayer and a conductive resin layer.

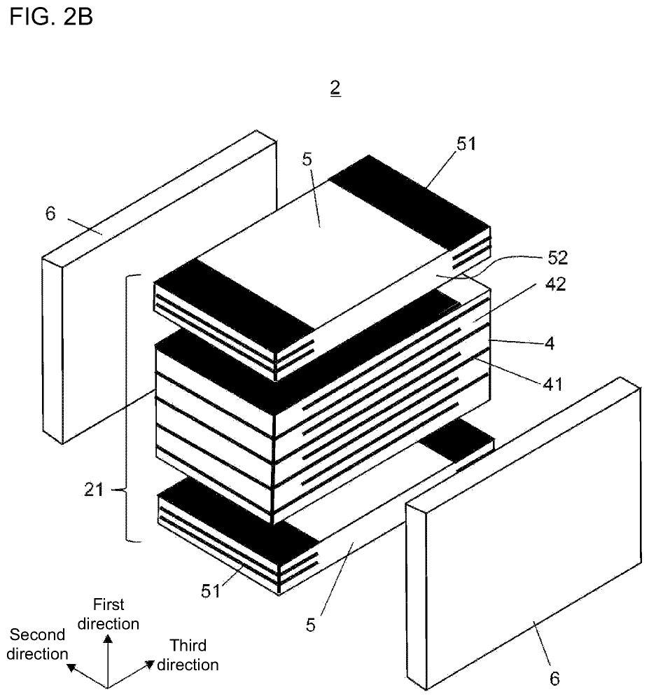

FIG. 2A is a schematic diagram of the component body 2 in one embodiment of the present disclosure. FIG. 2B is a schematic diagram of the component body 2 with its portions separate from one another. As illustrated in FIG. 2B, the component body 2 includes the multilayer portion 4, a pair of main surface protective layers 5 located on opposite main surfaces of the multilayer portion 4 in the first direction, and a pair of side protective layers 6 located on opposite side surfaces of the multilayer portion 4 and the main surface protective layers 5 in the second direction. Note that the multilayer portion 4 and the main surface protective layers 5 may be collectively referred to as the base component 23.

The component body 2 illustrated in each of FIGS. 2A and 2B can be the component body 2 before firing and can also be the component body 2 after firing. The component body 2 after firing has substantially the same structure as the component body 2 before firing, although being contracted through firing.

The multilayer portion 4 includes multiple internal electrode layers 41 connected to the external electrodes 3 and multiple dielectric layers 52 stacked in the first direction. The dielectric layers 52 may contain any of various ceramic dielectrics as a main component. For example, the dielectric layers 52 contain barium titanate as a main component. The internal electrode layers 41 may contain a metal such as nickel, palladium, silver, or copper as a main component. For example, the internal electrode layers 41 contain nickel as a main component. In one or more embodiments of the present disclosure, the main component refers to a component that constitutes higher than or equal to 80% of the total.

The pair of main surface protective layers 5 are located on the opposite main surfaces of the multilayer portion 4 in the first direction. As illustrated in FIGS. 2A and 2B, each of the main surface protective layers 5 includes dielectric layers 52 and plates 51. The dielectric layers 52 and the plates 51 are stacked in the first direction.

The dielectric layers 52 may contain any appropriate component as a main component. For example, the dielectric layers 52 may contain the same main component as the dielectric layers 52 in the multilayer portion 4.

The plates 51 may contain any appropriate component as a main component. For example, the plates 51 may contain a metal such as nickel, palladium, silver, or copper, or a ceramic material as a main component. In one embodiment of the present disclosure, for example, the plates 51 may contain the same main component as the internal electrode layers 41 in the multilayer portion 4.

In one embodiment of the present disclosure, as illustrated in FIGS. 2A and 2B, the plates 51 are located adjacent to opposite ends of each of the main surface protective layers 5 in the third direction. However, the plates 51 may be located at any positions adjacent to the opposite ends of the main surface protective layers 5 instead of their positions illustrated in FIGS. 2A and 2B. In the example in FIGS. 2A and 2B, the plates 51 extend in the third direction from opposite end faces of the main surface protective layers 5. In other words, in the example in FIGS. 2A and 2B, the plates 51 are partially located on the opposite end faces of each of the main surface protective layers 5 in the third direction.

The plate 51 may have any appropriate shape when viewed in the first direction. More specifically, in one embodiment of the present disclosure, the plates 51 are rectangular with long sides in the second direction and short sides in the third direction when viewed in the first direction.

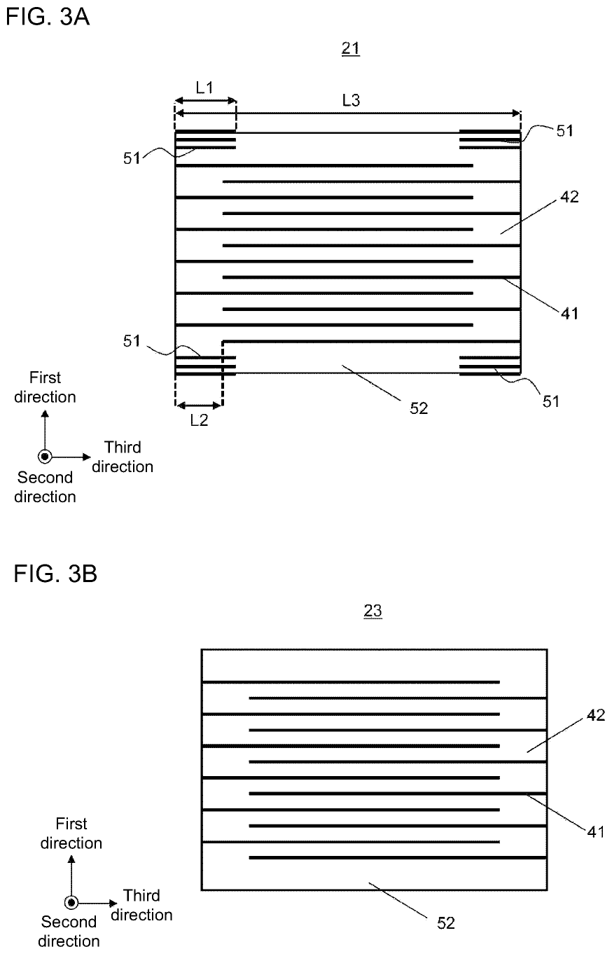

FIG. 3A is a schematic side view of the base component 23 when viewed in the second direction. In the pair of main surface protective layers 5, the plates 51 are located adjacent to opposite sides of each of the main surface protective layers 5 in the third direction. Thus, as illustrated in FIG. 3A, the plates 51 are located at four corners of a side surface of the base component 23 when viewed in the second direction. As described above, the plates 51 placed at the four corners of the side surface of the base component 23 reduce bonding failure of the side protective layer 6 at the four corners of the unfired base component 23.

FIG. 3B illustrates the base component 23 without the plates 51 in the main surface protective layers 5 as a comparative example. In other words, the base component 23 in FIG. 3B includes the main surface protective layers 5 including the dielectric layers 52 alone. When the side protective layers 6 are bonded to the side surfaces of the unfired base component 23 by pressing, bonding failure is more likely to occur at the four corners than in a central area of the side surfaces.

Although the central area of each of the side surfaces including rigid components such as the internal electrode layers 41 is more likely to receive pressure, the four corners of each of the side surfaces including no rigid components such as the internal electrode layers 41 are less likely to receive pressure. In the comparative example, insufficient pressing force is thus likely to be at the four corners of each of the side surfaces of the base component 23. This increases the likelihood of bonding failure of the side protective layer 6. The pressing force to attach the side protective layers 6 may be increased. However, any increased pressing force on the unfired base component 23 that is soft is likely to deform the internal electrode layers 41 and the dielectric layers 52 or to cause separation between layers. When bonding failure is likely to occur between the base component 23 and the side protective layers 6, external moisture is more likely to enter the structure, thus reducing moisture resistance.

In one embodiment of the present disclosure, the multilayer ceramic electronic component 1 includes the plates 51 located at the four corners of each of the side surfaces of the base component 23 to allow pressure to be applied easily at the four corners of the side surface of the base component 23 when the side protective layer 6 is bonded to the side surface of the base component 23. This reduces bonding failure of the side protective layer 6 at the four corners of the base component 23. The plates 51 located adjacent to the opposite ends of the main surface protective layers 5 and the base component 23 reduce the deformation of the internal electrode layers 41 and the dielectric layers 52 under pressure applied on the side surfaces of the base component 23. In one embodiment of the present disclosure, the multilayer ceramic electronic components can thus have a higher moisture resistance.

As illustrated in FIGS. 3A and 3B, in one embodiment of the present disclosure, L1≥L2 may be satisfied, where L1 is defined as the length of each of the plates 51 in the third direction, and L2 is defined as the length in the third direction from one end face of the multilayer portion 4 to an end of one of the internal electrode layers 41 extending from the other end face of the multilayer portion 4.

In fabricating the base component 23, the multilayer portion 4 and the main surface protective layers 5 are stacked and then pressed in the first direction to strengthen the bond between the internal electrode layers 41 and the dielectric layers 52. When the base component 23 is pressed in the first direction in this manner, areas including a higher proportion of rigid components, such as the internal electrode layers 41, receive a higher pressure and thus have stronger bond. However, areas including a lower proportion of rigid components, such as the internal electrode layers 41, are less likely to receive pressure and thus have weaker bond between the internal electrode layers 41 and the dielectric layers 52. Weak bond between the internal electrode layers 41 and the dielectric layers 52 increases the likelihood of entry of moisture, reducing moisture resistance.

Each of the internal electrode layers 41 extends from one end face of the multilayer portion 4 to a position near the other end face. In other words, one end face of the multilayer portion 4 and the end of one of the internal electrode layers 41 extending from the other end face of the multilayer portion 4 are apart from each other, defining an area with no internal electrode layer 41. Thus, the base component 23 includes portions adjacent to the opposite ends in the third direction each including fewer internal electrode layers 41 than the other portions when viewed in plan in the first direction. Thus, when the base component 23 is pressed in the first direction, the portions of the base component 23 located adjacent to the opposite ends in the third direction when viewed in the first direction are less likely to receive pressure, and thus more likely to have weaker bond between the internal electrode layers 41 and the dielectric layers 52.

As in one embodiment of the present disclosure, the base component 23 is more likely to receive pressure at positions adjacent to the opposite ends in the third direction when the structure including the plates 51 located adjacent to the opposite ends of the base component 23 in the third direction is pressed in the first direction. This improves bond between the internal electrode layers 41 and the dielectric layers 52 at the positions adjacent to the opposite ends of the base component 23 in the third direction and allows the multilayer ceramic electronic component to have a higher moisture resistance.

When L1≥L2 is satisfied, the plates 51 may overlap areas that are less likely to receive pressure when viewed in the first direction. Thus, when pressed in the first direction, the base component 23 is more likely to receive pressure at the positions adjacent to the opposite ends of the base component 23 in the third direction. This improves bond between the internal electrode layers 41 and the dielectric layers 52. The base component 23 with improved bond at the positions adjacent to the opposite ends reduces moisture entry through the positions, allowing the multilayer ceramic electronic component to have a higher moisture resistance. The base component 23 with improved bond at the positions adjacent to the opposite ends also increases the strength of the base component 23 at the positions adjacent to the opposite ends, allowing pressure to be applied more easily and effectively in wide areas around the four corners of each of the side surfaces of the base component 23 when the side protective layer 6 is bonded to the side surface of the base component 23. This effectively reduces bonding failure of the side protective layer 6 at the four corners of the base component 23.

When L1≥L2 is satisfied, the plates 51 at the four corners of each of the side surfaces of the base component 23 are longer in the third direction. This allows pressure to be applied more easily in wider areas when the side protective layers 6 are bonded to the side surfaces of the base component 23, thus reducing bonding failure of the side protective layer 6 in wider areas around the four corners of the base component 23. When L1≥L2 is satisfied, the deformation of the internal electrode layers 41 and the dielectric layers 52 under pressure on the side surfaces of the base component 23 is also reduced in wider areas. Thus, when L1≥L2 is satisfied as in one embodiment of the present disclosure, the multilayer ceramic electronic component 1 can have a higher moisture resistance.

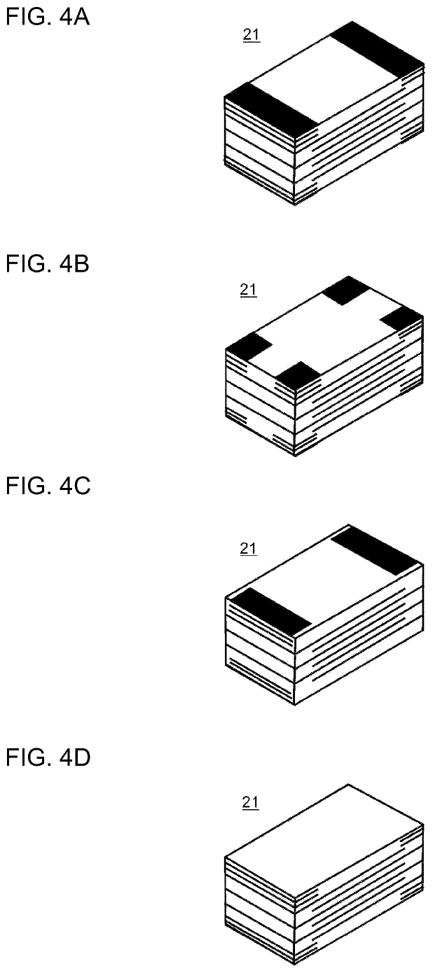

FIGS. 4A to 4D illustrate an example and variations of the base component 23 in the multilayer ceramic electronic component 1 according to one or more embodiments of the present disclosure. In the example of the base component 23 in FIG. 4A, the plates 51 are at least partially located on the main surface of at least one of the main surface protective layers 5 in the first direction. In the example of the base component 23 in FIG. 4A, the plates 51 are at least partially located on a side surface of at least one of the main surface protective layers 5 in the second direction.

The plates 51 at least partially located on the main surface of at least one of the main surface protective layers 5 in the first direction allow pressure to be applied more easily at the four corners of each of the side surfaces of the base component 23. This effectively reduces bonding failure of the side protective layer 6. The plates 51 at least partially located on the side surface of at least one of the main surface protective layers 5 in the second direction also allow pressure to be applied more easily at the four corners of each of the side surfaces of the base component 23. This effectively reduces bonding failure of the side protective layer 6.

In one or more embodiments of the present disclosure, the base component 23 in the multilayer ceramic electronic component 1 is not limited to the example in FIG. 4A. For example, the plates 51 may be located at the four corners of the main surface of the main surface protective layer 5 separated from each other when the main surface protective layers 5 are viewed in plan in the first direction, as in the variation of the base component 23 illustrated in FIG. 4B.

In the variation of the base component 23 in FIG. 4B as well, the plates 51 are at least partially located on the main surface of at least one of the main surface protective layers 5 in the first direction, and the plates 51 are at least partially located on the side surface of at least one of the main surface protective layers 5 in the second direction. This allows pressure to be applied more easily at the four corners of each of the side surfaces of the base component 23, more effectively reducing bonding failure of the side protective layer 6.

In the examples in FIGS. 4A and 4B, the plates 51 are at least partially located on the main surface and the side surface of at least one of the main surface protective layers 5, but the structure is not limited to these examples. As illustrated in FIG. 4C, for example, the plates 51 may not be located on the side surfaces of the main surface protective layers 5 in the second direction. In other words, the plates 51 may be located inward in the main surface protective layers 5 in the second direction. As illustrated in FIG. 4D, the plates 51 may not be located on the main surfaces of the main surface protective layers 5 when viewed in the first direction. In other words, the plates 51 may be located inward in the main surface protective layers 5 in the first direction.

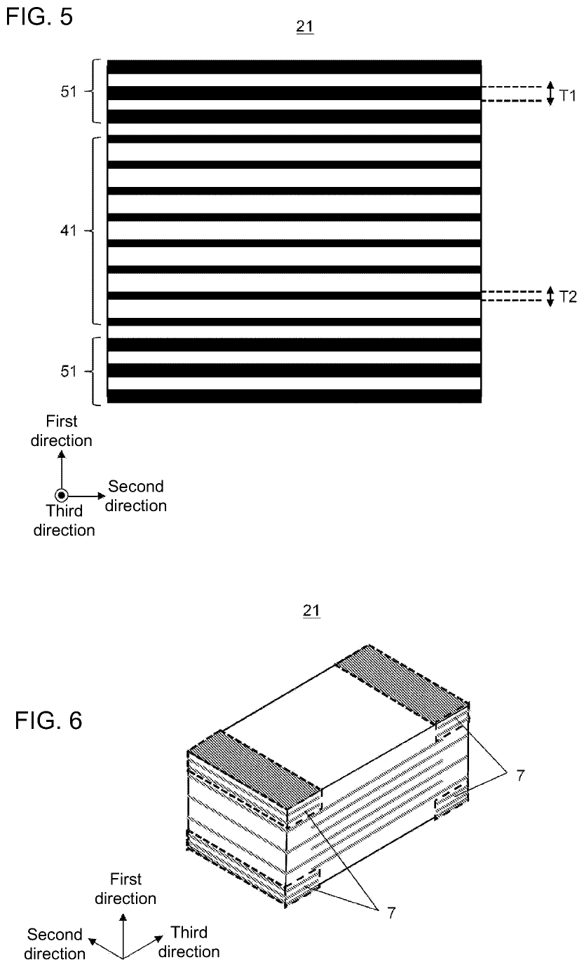

In one embodiment of the present disclosure illustrated in FIGS. 2A and 2B, the plates 51 in the component body 2 have the same thickness, but the structure is not limited to this example. The plates 51 may have different thicknesses as appropriate. For example, as illustrated in FIG. 5, T1≥T2 may be satisfied, where T1 is defined as the thickness of each of the plates 51 in the first direction, and T2 is defined as the thickness of each of the internal electrode layers 41 in the first direction.

This structure allows the plates 51 to have a higher strength than the internal electrode layers 41, allowing pressure to be applied more easily at the four corners of each of the side surfaces of the base component 23 when the side protective layer 6 is bonded to the side surface of the base component 23. This effectively reduces bonding failure of the side protective layer 6 at the four corners of the base component 23. When T1≥T2 is satisfied, the plates 51 have a higher strength. This effectively reduces the deformation of the internal electrode layers 41 and the dielectric layers 52 under pressure on the side surfaces of the base component 23. Thus, when T1≥T2 is satisfied, the multilayer ceramic electronic component 1 can have a higher moisture resistance.

In one embodiment of the present disclosure, each of the main surface protective layers 5 in the multilayer ceramic electronic component 1 includes main surface protective layer ends 7 that are portions overlapping the plates 51 when viewed in plan in the first direction. The main surface protective layer ends 7 are, for example, portions of the base component 23 defined by dashed lines in FIG. 6. In one embodiment of the present disclosure, for example, each of the plates 51 may have a volume percentage of 20% or more of the volume of the corresponding main surface protective layer end 7.

This structure allows the main surface protective layer ends 7 located at the four corners of each of the side surfaces of the base component 23 to have a higher strength, allowing pressure to be applied easily at the four corners of the side surface of the base component 23 when the side protective layer 6 is bonded to the side surface of the base component 23. This effectively reduces bonding failure of the side protective layer 6 at the four corners of the base component 23. The main surface protective layer ends 7 with a higher strength effectively reduce the deformation of the internal electrode layers 41 and the dielectric layers 52 under pressure on the side surfaces of the base component 23. Thus, each of the plates 51 with a volume percentage of 20% or more of the volume of the corresponding main surface protective layer end 7 allows the multilayer ceramic electronic component 1 to have a higher moisture resistance.

In one embodiment of the present disclosure, the plates 51 contain the same main component as the internal electrode layers 41 in the multilayer portion 4. The plates 51 with the main component that is the same as or similar to the main component of the internal electrode layers 41 are less likely to have internal defects such as cracks and delamination due to difference in shrinkage during firing.

The plates 51 may not contain exactly the same components as the internal electrode layers 41, and may contain components adjusted as appropriate. For example, the plates 51 may contain a ceramic component in addition to the same main component as the internal electrode layers 41. In this case, the content of the ceramic component in the plates 51 may be adjusted as appropriate. For example, the content of the ceramic component in the plates 51 may be greater than or equal to the content of the ceramic component in the internal electrode layers 41.

This structure allows the plates 51 located at the four corners of each of the side surfaces of the base component 23 to have a higher strength than the internal electrode layers 41, allowing pressure to be applied easily at the four corners of the side surface of the base component 23 when the side protective layer 6 is bonded to the side surface of the base component 23. This effectively reduces bonding failure of the side protective layer 6 at the four corners of the base component 23. The plates 51 with a higher strength effectively reduce the deformation of the internal electrode layers 41 and the dielectric layers 52 under pressure on the side surfaces of the base component 23. Thus, the structure including the plates 51 with a volume percentage of 20% or more of the volume of each of the internal electrode layers 41 allows the multilayer ceramic electronic component 1 to have a higher moisture resistance.

In one embodiment of the present disclosure, the plates 51 contain the same main component as the internal electrode layers 41 in the multilayer portion 4, but the structure is not limited to this example. For example, the plates 51 may contain a ceramic component as a main component and other components such as additives. The plates 51 may contain the ceramic component alone.

In one embodiment of the present disclosure, one of the main surface protective layers 5 may include any number of plates 51 stacked in the first direction. For example, one plate 51 or multiple plates 51 may be stacked in the first direction. For example, one of the main surface protective layers 5 may include three or more plates 51 stacked in the first direction.

This structure allows more plates 51 to be located at the four corners of each of the side surfaces of the base component 23, allowing pressure to be applied easily at the four corners of the side surface of the base component 23 when the side protective layer 6 is bonded to the side surface of the base component 23. This effectively reduces bonding failure of the side protective layer 6 at the four corners of the base component 23. More plates 51 being stacked can effectively reduce the deformation of the internal electrode layers 41 and the dielectric layers 52 under pressure on the side surfaces of the base component 23. One of the main surface protective layers 5 with three or more plates 51 stacked in the first direction allows the multilayer ceramic electronic component 1 to have a higher moisture resistance.

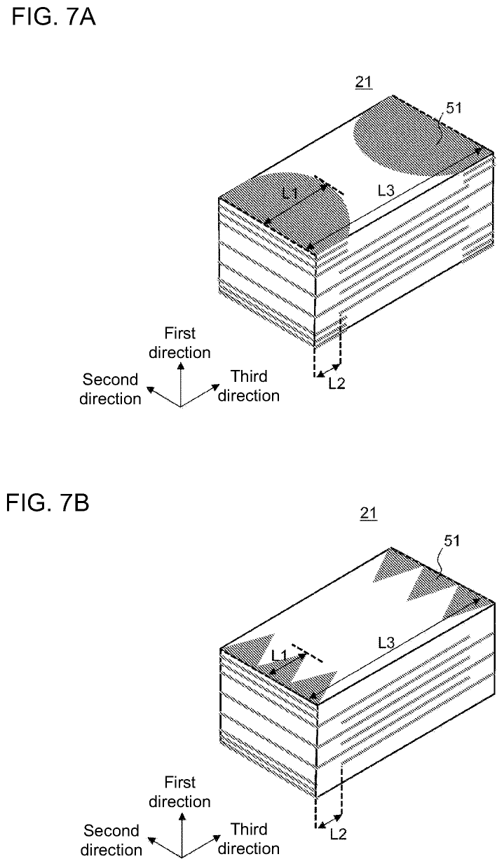

In one embodiment of the present disclosure, the plates 51 are rectangular with the long sides in the second direction and the short sides in the third direction when viewed in the first direction. However, the structure is not limited to this example. The plates 51 may have any shape when viewed in the first direction. For example, the plates 51 may be oval as illustrated in FIG. 7A, or triangular as illustrated in FIG. 7B when viewed in the first direction.

For the plates 51 illustrated in FIGS. 7A and 7B, the length L1 may be defined as the length of each of the plates 51 in the third direction with reference to any portion of the plate 51. For example, as illustrated in FIGS. 7A and 7B, the length L1 may be defined as the length of a longest portion of the plate 51 in the third direction.

In the above examples of one embodiment of the present disclosure, the length L2 is the same for the multiple internal electrode layers 42, where the length L2 is the length in the third direction from one end face of the multilayer portion 4 to the end of one of the internal electrode layers 41 extending from the other end face of the multilayer portion 4. However, the structure is not limited to this example. The multiple internal electrode layers 41 may have the same length L2 or different lengths L2.

When the multiple internal electrode layers 41 have different lengths L2, for example, a smallest length, a largest length, or an average length may be defined as L2 as a representative length.

As illustrated in FIG. 3A, L3 is defined as the length in the third direction from one end face to the other end face of one of the main surface protective layers 5. The length LI relative to the length L3 may be defined as appropriate. In one embodiment of the present disclosure, for example, L1≥(⅛)×L3 may be satisfied.

This structure allows the plates 51 located at the four corners of each of the side surfaces of the base component 23 to be longer in the third direction, allowing pressure to be applied easily in wide areas around the four corners of each of the side surfaces of the base component 23 when the side protective layer 6 is bonded to the side surface of the base component 23. This effectively reduces bonding failure of the side protective layer 6 at the four corners of the base component 23. When L1≥(¼)×L3 is satisfied, the deformation of the internal electrode layers 41 and the dielectric layers 52 under pressure on the side surfaces of the base component 23 is reduced in wider areas. Thus, when L1≥(⅛)×L3 is satisfied as in one embodiment of the present disclosure, the multilayer ceramic electronic component 1 can have a higher moisture resistance.

### Method for Manufacturing Multilayer Ceramic Electronic Component

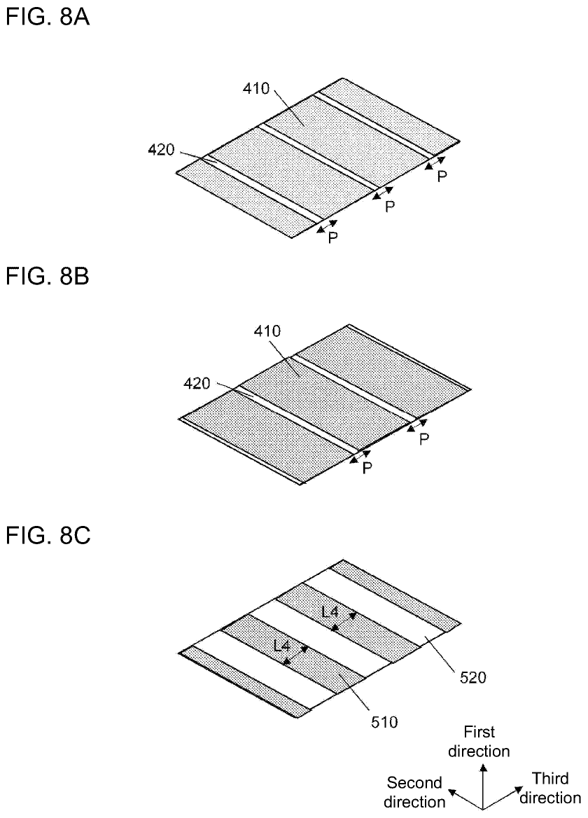

A method for manufacturing the component body 2 and the multilayer ceramic electronic component 1 according to one or more embodiments of the present disclosure will now be described with reference to FIGS. 8A to 8C.

Dielectric sheets are first prepared by placing each of the dielectric sheets on a carrier film and drying. Dielectric sheets 420 may have a thickness of, for example, about 1 to 10 μm. The dielectric sheets 420 having a smaller thickness can increase the capacitance of the multilayer ceramic capacitor. The dielectric sheets 420 are placed using, for example, a die coater, but may be placed with any other method. The dielectric sheets 420 may be placed using, for example, a doctor blade coater or a gravure coater.

The dielectric sheets 420 may be made of any of various ceramic dielectric materials. For example, the dielectric sheets 420 are prepared by wet-grinding and mixing a ceramic mixture powder containing barium titanate and an additive using a bead mill and by mixing the resultant slurry with a polyvinyl butyral binder, a plasticizer, and an organic solvent.

As illustrated in FIGS. 8A and 8B, electrodes 410 to be the internal electrode layers 41 later are printed at intervals on each of the dielectric sheets 420 prepared as described above. FIGS. 8A and 8B illustrate the electrodes 410 containing a metal material to be the internal electrode layers 41 printed in two different conductive patterns with different polarities. The electrodes 410 may be made of any of various metals. More specifically, in one embodiment of the present disclosure, the electrodes 410 are made of a conductive paste containing Ni as a main component.

Each of the electrodes 410 may have a minimum thickness that achieves the functions of the capacitor. This can reduce internal defects resulting from internal stress. For a capacitor with a stack of many layers, the electrodes 410 may each have, for example, a thickness less than or equal to 1.0 μm.

The electrodes 410 are printed at intervals of a distance P.

FIG. 8C illustrates a dielectric sheet 520 to be one of the main surface protective layers 5, with base plates 510 to form the plate 51 later printed on the dielectric sheet 520 in a strip pattern. When the dielectric sheets 520 are stacked and cut into the base components 23, each of the strip-shaped plates 51 extends as a continuous plate across a pair of cut side surfaces. A length L4 is greater than or equal to the distance P, where L4 is defined as the length of each of the plates 51 in the second direction. However, for the plates 51 located at the ends of the dielectric sheet 520, the length L4 may or may not be greater than or equal to the distance P.

The base plates 510 may contain a metal such as Ni, Pd, Cu, or Ag or an alloy of these metals. More specifically, in one embodiment of the present disclosure, the base plates 510 are made of the same conductive paste containing Ni as a main component as the electrodes 410 to allow firing under the same conditions as the electrodes 410.

The electrodes 410 and the base plates 510 are printed by screen printing, but the printing is not limited to this example. For example, gravure printing may be used.

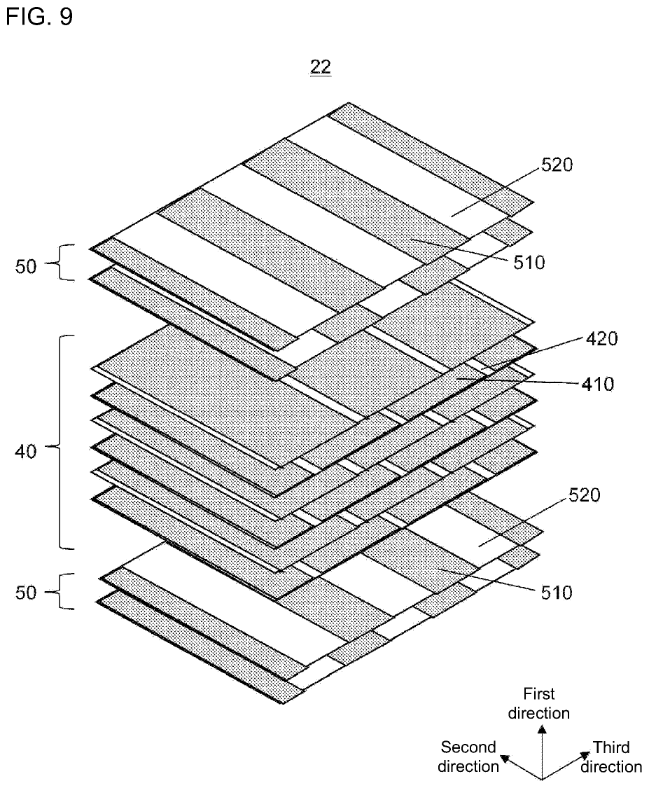

FIG. 9 is a schematic perspective view of the dielectric sheets 420 on which the electrodes 410 are printed and the dielectric sheets 520 on which the base plates 510 are printed being stacked in the first direction. One or more dielectric sheets 520 on which the base plates 510 are printed are stacked. Multiple dielectric sheets 420 on which the electrodes 410 with different polarities are printed are then stacked alternately on the stack of the dielectric sheets 520. On the resultant stuck, one or more dielectric sheets 520 on which the base plates 510 are printed are further stacked. Each of the base plates 510 is placed at a position overlapping the corresponding one of the intervals of the distance P between the electrodes when viewed in the first direction.

As illustrated in FIG. 9, a portion of one or more dielectric sheets 520 on which the base plates 510 are printed is specifically referred to as a main surface protector 50. A portion of multiple dielectric sheets 420 on which the electrodes 410 with different polarities are printed stacked alternately is referred to as a stack 40.

As described above, the multilayer base 220 is fabricated by placing a pair of main surface protectors 50 on the opposite ends of the stack 40 including the multiple electrodes 410 and the multiple dielectric sheets 420 stacked in the first direction. This process is referred to as a first process.

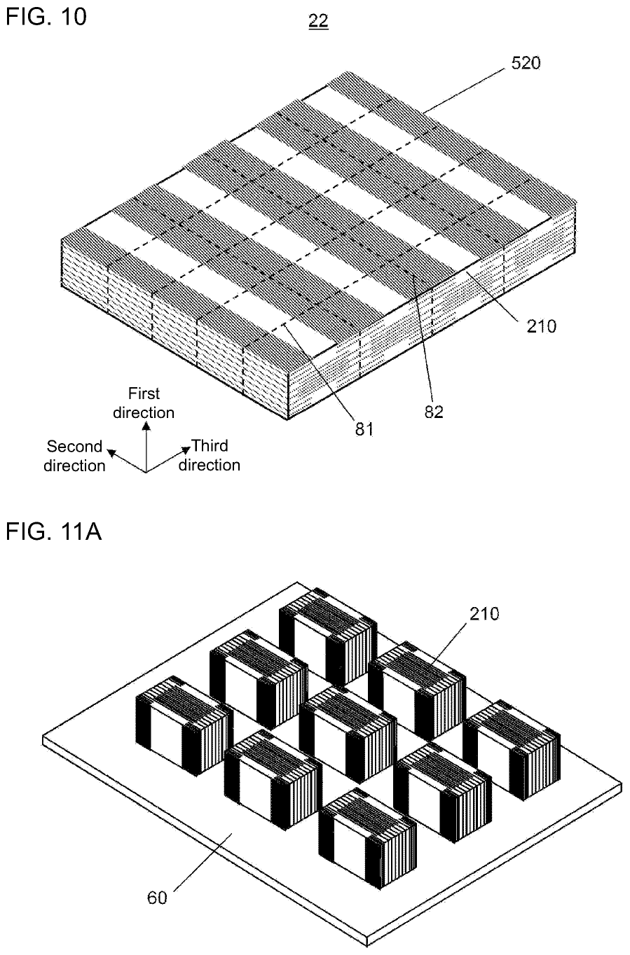

The multilayer base 220 is then pressed in the first direction that is the stacking direction to obtain the multilayer base 220 as a single piece as illustrated in FIG. 10. This process is referred to as a second process. The pressing may be performed using, for example, a hydrostatic pressing device.

In the process of pressing in the first direction, portions including more interleaves such as the electrodes 410 receive a higher pressure, increasing bond between the electrodes 410 and the dielectric sheets 420. However, portions including less interleaves are less likely to receive pressure, decreasing bond between the electrodes 410 and the dielectric sheets 420.

In one embodiment of the present disclosure, each of the base plates 510 is placed at a position overlapping the corresponding one of the intervals of the distance P between the electrodes 410 when viewed in the first direction. Thus, with the base plates 510, the portions that are less likely to receive pressure without the base plates 510 during pressing in the second process, or in other words, portions overlapping the intervals between the electrodes 410, can receive a higher pressure. This improves bond between the electrodes 410 and the dielectric sheets 420 in these portions.

Subsequently, the multilayer base 220 is cut along planes orthogonal to the third direction intersecting with the first direction. The cutting planes are illustrated in FIG. 10 as cutting lines 82. This process is referred to as a third process. In the same or similar manner, the multilayer base 220 is cut along planes orthogonal to the second direction intersecting with the third direction. The cutting planes are illustrated in FIG. 10 as cutting lines 81. This process is referred to as a fourth process. Note that either the third process or the fourth process may precede.

The multilayer base 220 is cut in the third process and the fourth process to obtain base precursors 210 to be the base components 23 through firing. Note that the cutting is performed using, for example, a press-cutter, but may be cut with any other method. The cutting may be performed using, for example, a dicing saw.

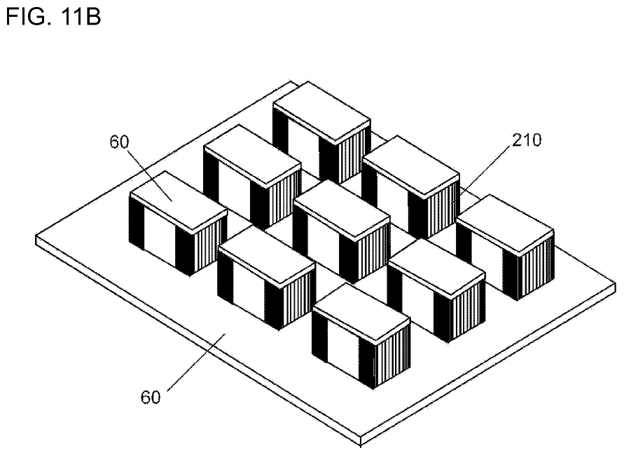

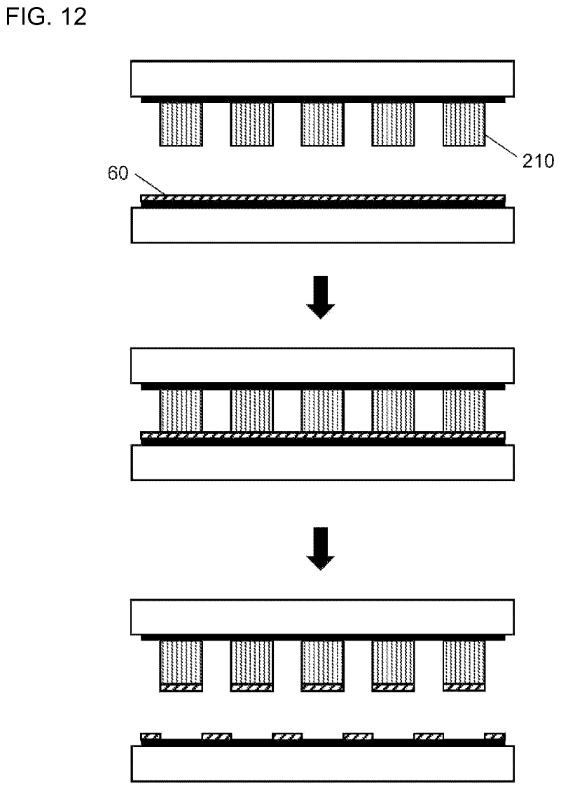

As illustrated in FIG. 11A, the unfired base precursors 210 are then aligned with their cut side surfaces in the second direction uncovered, and a side protector 60 is attached.

The material for the side protector 60 may be any material. The material may be any material that is easy to bond to the unfired base precursors 210 and does not affect the product properties through firing. For example, a ceramic raw material for the side protector 60 may have a composition that is the same as or similar to the composition of the base precursors 210. A degreasing process before firing removes any organic components such as organic binders and solvents. The material for the side protector 60 may thus have any composition that allows easy bonding to the base precursors 210.

For example, a polyvinyl butyral binder may be used as an organic binder for the side protector 60 in one embodiment of the present disclosure. Polyvinyl butyral binders have high plasticity and high adhesion. A binder with a low glass transition temperature Tg used with a plasticizer can further increase adhesion when heated to a temperature higher than Tg by 30° C. or more. Such a binder and a plasticizer may be dissolved in a mixed solvent of ethanol and toluene, and mixed and dispersed into a slip of a ceramic raw material to fabricate the side protector 60.

As illustrated in FIG. 12, the cut side surfaces being lower surfaces of the base precursors 210 are pressed against the side protector 60. This bonds the portions of the side protector 60 placed into contact with the base precursors 210 to the base precursors 210.

On the cut side surfaces to be attached, the base plates 510 that satisfy L1≥L2 are included in the main surface protectors 50 at the four corners. This allows pressure to be applied uniformly across the entire surface to be attached. Thus, the pressure for attaching the side protector 60 is easily controllable, reducing bonding failure of the side protector 60. As compared with the structure with no base plates 510, this structure eliminates extra pressure for reattaching the side protector 60 to, for example, any deformed portion, thus allowing the reattaching to be performed with a lower pressure. The pressing force may be, for example, 30 to 100 kg/cm².

In FIG. 11A, the side protector 60 is attached to one of the cut side surfaces. Another side protector 60 is also attached to the other of the cut side surfaces in the same or similar manner. FIG. 11B illustrates this process. The process of attaching the side protector 60 to the cut side surfaces of the unfired base precursors 210 is referred to as a fifth process.

Through the above processes, the unfired component bodies 2 are obtained. The obtained unfired component bodies 2 are degreased in a nitrogen atmosphere, and then fired in a hydrogen-nitrogen atmosphere to obtain the component bodies 2 as illustrated in FIG. 2A.

After firing, end faces of the fired component bodies 2 are coated with a conductive paste mainly containing, for example, copper, and the component bodies 2 are fired again to form base electrodes for the external electrodes 3. The base electrodes are further plated with Ni, Sn, or Cu to form the external electrodes 3. The multilayer ceramic electronic components 1 illustrated in FIG. 1 are thus obtained. The external electrodes 3 may further contain a conductive resin electrode material. The external electrodes 3 are formed by dip-coating with a conductive paste such as a Cu paste, but the external electrodes 3 may also be formed by growing metallic plating such as Cu plating using exposed metal portions of the component body 2 as cores.

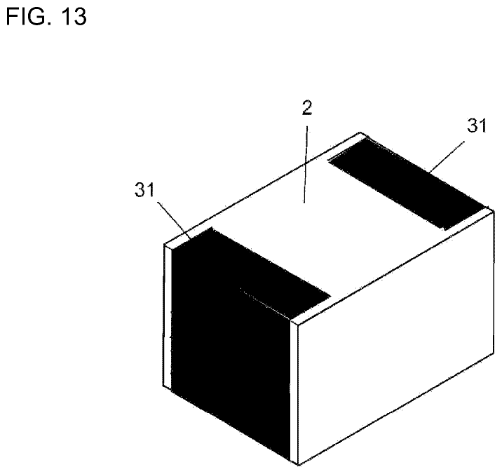

FIG. 13 illustrates an example component body 2 in FIG. 2A with underlayers 31 each formed by electroless Cu plating or electrolytic Cu plating and overlaid with an electrolytic Ni plating layer and an electrolytic Sn plating layer. However, the underlayers 31 may be formed with any other method. For example, the underlayers 31 may be formed using both electroless Cu plating and electrolytic Cu plating. The underlayers 31 each may be plated directly, and a resin electrode may be attached on the underlayers 31.

The multilayer ceramic electronic component and the method for manufacturing the multilayer ceramic electronic component described above reduce bonding failure between the multilayer portion and the side protective layers, and the resultant multilayer ceramic electronic component can have a higher moisture resistance.

The multilayer ceramic electronic component according to one or more embodiments of the present disclosure may have aspects (1) to (10) described below.

(1) A multilayer ceramic electronic component, comprising:
a multilayer portion including a plurality of internal electrode layers and a plurality of dielectric layers stacked in a first direction;
a pair of main surface protective layers located on opposite main surfaces of the multilayer portion in the first direction;
a pair of side protective layers located on opposite side surfaces of the multilayer portion and the pair of main surface protective layers in a second direction intersecting with the first direction; and
a plate located adjacent to each of opposite ends of each of the pair of main surface protective layers in a third direction intersecting with the second direction,
wherein L1≥L2, where L1 is a length of the plate in the third direction, and L2 is a length in the third direction from one end face of the multilayer portion to an end of an internal electrode layer of the plurality of internal electrode layers extending from the other end face of the multilayer portion.

(2) The multilayer ceramic electronic component according to (1), wherein
the plate is located on a main surface of at least one of the pair of main surface protective layers in the first direction.

(3) The multilayer ceramic electronic component according to (1), wherein
the plate is partially located on a side surface of at least one of the pair of main surface protective layers in the second direction.

(4) The multilayer ceramic electronic component according to (1), wherein
T1≥T2, where T1 is a thickness of the plate in the first direction, and T2 is a thickness of each of the plurality of internal electrode layers in the first direction.

(5) The multilayer ceramic electronic component according to (1), wherein
each of the pair of main surface protective layers includes a main surface protective layer end being a portion overlapping the plate when viewed in plan in the first direction, and
the plate has a volume percentage of 20% or more of a volume of the main surface protective layer end.

(6) The multilayer ceramic electronic component according to (1), wherein
the plate comprises a same main component as the plurality of internal electrode layers.

(7) The multilayer ceramic electronic component according to (6), wherein
the plate comprises a ceramic component, and
a content of the ceramic component in the plate is greater than or equal to a content of a ceramic component in the plurality of internal electrode layers.

(8) The multilayer ceramic electronic component according to (1), further comprising:
one or more plates stacked in the first direction, the one or more plates stacked in the first direction being three or more plates.

(9) The multilayer ceramic electronic component according to (1), wherein
the length L2 is a smallest length of lengths in the third direction from one end face of the multilayer portion to ends of the plurality of internal electrode layers extending from the other end face of the multilayer portion.

(10) The multilayer ceramic electronic component according to (1), wherein
the length L1 is a longest portion of the plate in the third direction.

The method for manufacturing the multilayer ceramic electronic component according to one or more embodiments of the present disclosure may have an aspect (11) described below.

(11) A method for manufacturing a multilayer ceramic electronic component, the method comprising:
fabricating a multilayer base by placing a pair of main surface protectors on opposite ends of a stack in a first direction, the stack including a plurality of electrodes and a plurality of dielectric sheets stacked in the first direction;
pressing the multilayer base in the first direction;
cutting the multilayer base along a plane orthogonal to a third direction intersecting with the first direction to form a pair of cut end faces;
cutting the multilayer base along a plane orthogonal to a second direction intersecting with the third direction to form a pair of cut side surfaces; and
attaching side protectors to the pair of cut side surfaces,
wherein the fabricating the multilayer base includes
   placing sections of an electrode of the plurality of electrodes on a dielectric sheet in each of the pair of main surface protectors at an interval of a distance P in the third direction, and
   placing a base plate having a length in the third direction greater than or equal to the distance P at a position overlapping the interval when viewed in the first direction.

Although embodiments of the present disclosure have been described in detail, the present disclosure is not limited to the embodiments described above, and may be changed or varied in various manners without departing from the spirit and scope of the present disclosure. The components described in the above embodiments may be entirely or partially combined as appropriate unless any contradiction arises.

### REFERENCE SIGNS

1 multilayer ceramic electronic component
2 component body
21 base component
210 base precursor
220 multilayer base
3 external electrode
31 underlayer
4 multilayer portion
40 stack
41 internal electrode layer
410 electrode
42 dielectric layer
420 dielectric sheet
5 main surface protective layer
50 main surface protector
51 plate
510 base plate
6 side protective layer
60 side protector
7 main surface protective layer end
81, 82 cutting line

1. A multilayer ceramic electronic component, comprising:
a multilayer portion including a plurality of internal electrode layers and a plurality of dielectric layers stacked in a first direction;
a pair of main surface protective layers located on opposite main surfaces of the multilayer portion in the first direction;
a pair of side protective layers located on opposite side surfaces of the multilayer portion and the pair of main surface protective layers in a second direction intersecting with the first direction; and
a plate located adjacent to each of opposite ends of each of the pair of main surface protective layers in a third direction intersecting with the second direction,
wherein L1≥L2, where L1 is a length of the plate in the third direction, and L2 is a length in the third direction from one end face of the multilayer portion to an end of an internal electrode layer of the plurality of internal electrode layers extending from the other end face of the multilayer portion.

2. The multilayer ceramic electronic component according to claim 1, wherein
the plate is located on a main surface of at least one of the pair of main surface protective layers in the first direction.

3. The multilayer ceramic electronic component according to claim 1, wherein
the plate is partially located on a side surface of at least one of the pair of main surface protective layers in the second direction.

4. The multilayer ceramic electronic component according to claim 1, wherein
T1≥T2, where T1 is a thickness of the plate in the first direction, and T2 is a thickness of each of the plurality of internal electrode layers in the first direction.

5. The multilayer ceramic electronic component according to claim 1, wherein
each of the pair of main surface protective layers includes a main surface protective layer end being a portion overlapping the plate when viewed in plan in the first direction, and
the plate has a volume percentage of 20% or more of a volume of the main surface protective layer end.

6. The multilayer ceramic electronic component according to claim 1, wherein
the plate comprises a same main component as the plurality of internal electrode layers.

7. The multilayer ceramic electronic component according to claim 6, wherein
the plate comprises a ceramic component, and
a content of the ceramic component in the plate is greater than or equal to a content of a ceramic component in the plurality of internal electrode layers.

8. The multilayer ceramic electronic component according to claim 1, further comprising:
one or more plates stacked in the first direction, the one or more plates stacked in the first direction being three or more plates.

9. The multilayer ceramic electronic component according to claim 1, wherein
the length L2 is a smallest length of lengths in the third direction from one end face of the multilayer portion to ends of the plurality of internal electrode layers extending from the other end face of the multilayer portion.

10. The multilayer ceramic electronic component according to claim 1, wherein
the length L1 is a longest portion of the plate in the third direction.

11. A method for manufacturing a multilayer ceramic electronic component, the method comprising:
fabricating a multilayer base by placing a pair of main surface protectors on opposite ends of a stack in a first direction, the stack including a plurality of electrodes and a plurality of dielectric sheets stacked in the first direction;
pressing the multilayer base in the first direction;
cutting the multilayer base along a plane orthogonal to a third direction intersecting with the first direction to form a pair of cut end faces;
cutting the multilayer base along a plane orthogonal to a second direction intersecting with the third direction to form a pair of cut side surfaces; and
attaching side protectors to the pair of cut side surfaces,
wherein the fabricating the multilayer base includes
placing sections of an electrode of the plurality of electrodes on a dielectric sheet in each of the pair of main surface protectors at an interval of a distance P in the third direction, and
placing a base plate having a length in the third direction greater than or equal to the distance P at a position overlapping the interval when viewed in the first direction.
